(19) United States
(12) Patent Application Publication
(10) Pub. No.: US 2024/0166429 A1
(43) Pub. Date: May 23, 2024

(54) BREWING CARTRIDGE

(71) Applicant: Brewing Works Limited, Hitchin Hertfordshire (GB)

(72) Inventor: Harrison Edwards, Hitchin Hertfordshire (GB)

(73) Assignee: Brewing Works Limited, Hitchin Hertfordshire (GB)

(21) Appl. No.: 18/283,538

(22) PCT Filed: Mar. 25, 2022
(86) PCT No.: PCT/IB2022/052744

§ 371 Date: Sep. 22, 2023

(30) Foreign Application Priority Data
Mar. 25, 2021 (GB) 2104233.8

(51) Int. Cl. B65D 85/804; B65D 81/32; C12C 13/10

(52) U.S. Cl. CPC B65D 85/8067; B65D 81/3222; C12C 13/10

(57) ABSTRACT

Apparatus comprising a cartridge device having a liquid inlet, a first substance-containing part downstream of the liquid inlet and for containing a first substance, a second substance-containing part for containing a second substance, the second substance being separated from the first substance, and releasing means arranged to release the first and second substances from respective first and second substance-containing parts.

This invention relates to brewing, and in particular home brewing using a cartridge containing all of the essential brewing ingredients to be attached to a fermentation chamber.

It is known to add, separately, brewing ingredients to a fermentation chamber for an extract-based brewing processes, which are popular home-brew methods for alcoholic beverages such as beer, cider and wine. This usually comprises emptying a container of extract into a fermentation chamber, followed by the addition of a measured quantity of liquid, such as water, for the amount of extract and then adding yeast from a separate sealed package. Other ingredients may also be added at the start of the fermentation process or after fermentation has started.

According to a first aspect of the present invention, there is provided apparatus comprising a cartridge device having a liquid inlet, a first substance-containing part downstream of the liquid inlet and for containing a first substance, and a second substance-containing part for containing a second substance, the second substance being separated from the first substance, the arrangement being such that releasing means serve to release the first and second substances from the respective first and second substance-containing parts.

According to a second aspect of the present invention, there is provided a method of brewing comprising mounting to a fermentation container a cartridge device having a liquid inlet, a first substance-containing part downstream of the liquid inlet and for containing a first substance, and a second substance-containing part for containing a second substance, the second substance being, initially, separated from the first substance, and subsequently releasing the first and second substances from the respective first and second substance-containing parts, directing liquid to flow into the liquid inlet and into the first substance-containing part to mix with the first substance, the mixed liquid flowing through a liquid outlet of the cartridge device to the fermentation container, the mixed liquid coming into contact with the released second substance.

According to a third aspect of the present invention, there is provided brewing apparatus comprising a fermentation container, a brewing ingredient cartridge device serving to supply a brewing ingredient contained in the cartridge to the fermentation container, the fermentation container including a cartridge-receiving device for mounting the cartridge to the fermentation container.

According to a fourth aspect of the present invention, there is provided a method of brewing comprising mounting a brewing ingredient cartridge device to a cartridge-receiving device of a fermentation container, directing a flow of liquid through the cartridge device mounted in the cartridge-receiving device so as to deliver a brewing ingredient contained in the cartridge device into the fermentation chamber.

Owing to these aspects, brewing ingredients can be supplied in a single cartridge device mountable to a fermentation chamber.

Advantageously, the cartridge device is a single-use cartridge to be used in a specially arranged vertical brewing stack as, for example, disclosed in International Patent Application Publication WO2019243783.

An initiating action is preferably applied to the cartridge device to release the ingredients therefrom in order to initiate a fermentation process.

Preferably, the first substance-containing part is relatively large in volume and contains a concentrated brew extract for brewing alcoholic beverages such as wine, beer or cider and the second substance-containing part is smaller in volume and contains the necessary quantity and type of yeast and/or any non-liquid ingredients to start the fermentation process. The cartridge device may also advantageously include a liquid filtering device fitted into the fluid inlet end of the cartridge to filter a liquid, such as water directed to flow therethrough in order to remove any impurities in the liquid.

Top and bottom end regions of the cartridge device are preferably sealed with openable seals to ensure ingredient integrity and safety. In addition, an action is preferably applied to the cartridge device body when mounting it to the fermentation container to open the seals at either end of the cartridge simultaneously or non-simultaneously.

The cartridge device is preferably made from a plastics material and, advantageously, a recyclable plastics material. The second substance-containing part may be in the form of a chamber formed in the moulding of the cartridge and separated from the first substance-containing part. Alternatively, the second substance-containing part could be a compartment separated from the first substance-containing part by a temporary membrane device or could be a separate pouch-like part inserted into the cartridge device.

Located downstream of the second substance-containing part, there is preferably a receptacle which is open to the internal space of the fermentation container. This receptacle may be made wholly or partially of a meshed material and which could extend downwardly from the bottom end of the cartridge device.

In order that the present invention can be clearly and completely disclosed, reference will now be made, by way of example only, to the accompanying drawings, in which:—

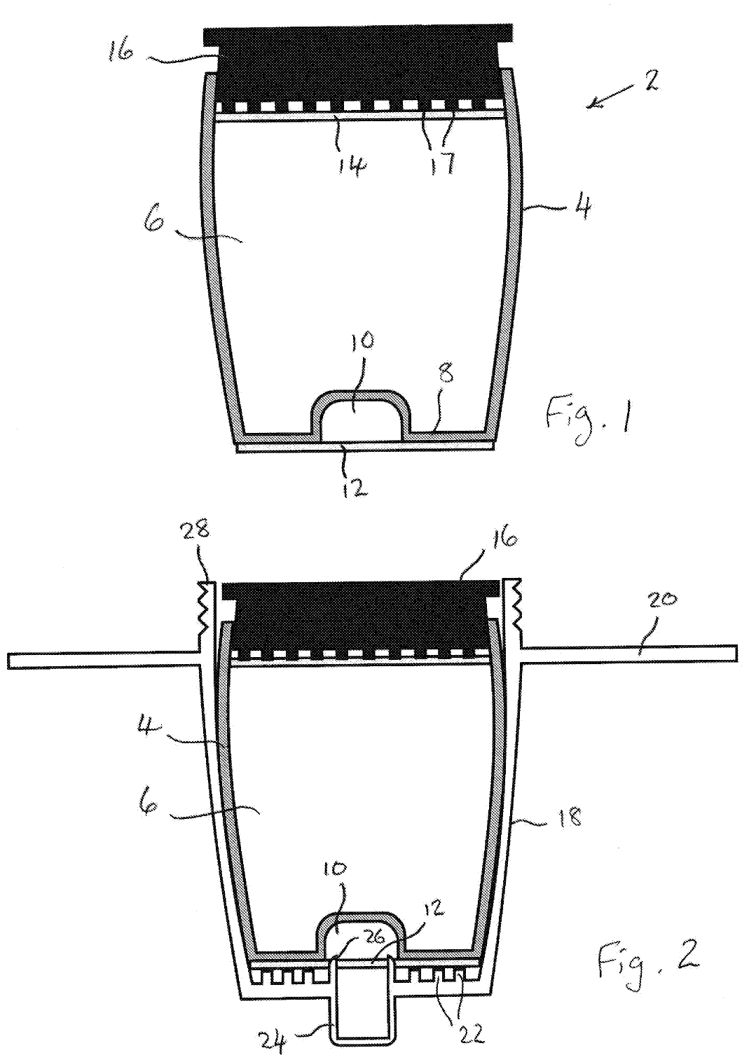

FIG. 1 is schematic cross-sectional view of a first embodiment of a brewing cartridge device,

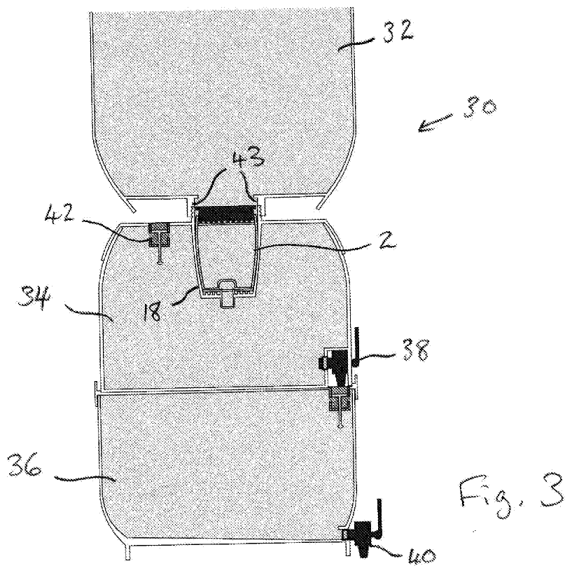

FIG. 2 is a view similar to FIG. 1, but of the brewing cartridge device inserted into a cartridge chamber of a fermentation chamber,

FIG. 3 is a schematic cross-sectional view of the first embodiment of the brewing cartridge device in a vertical stack brewing apparatus,

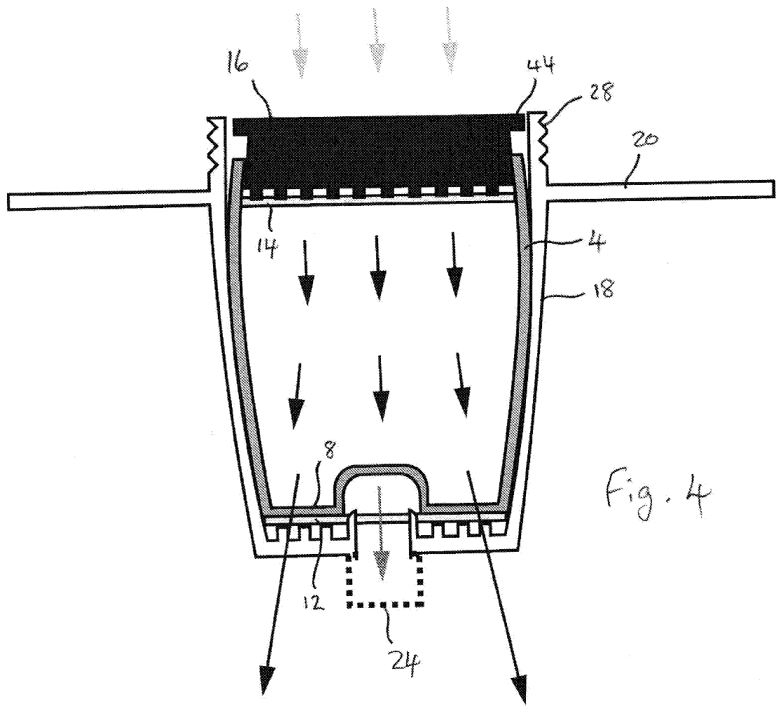

FIG. 4 is a view similar to FIG. 2 showing fluid flow through the brewing cartridge device,

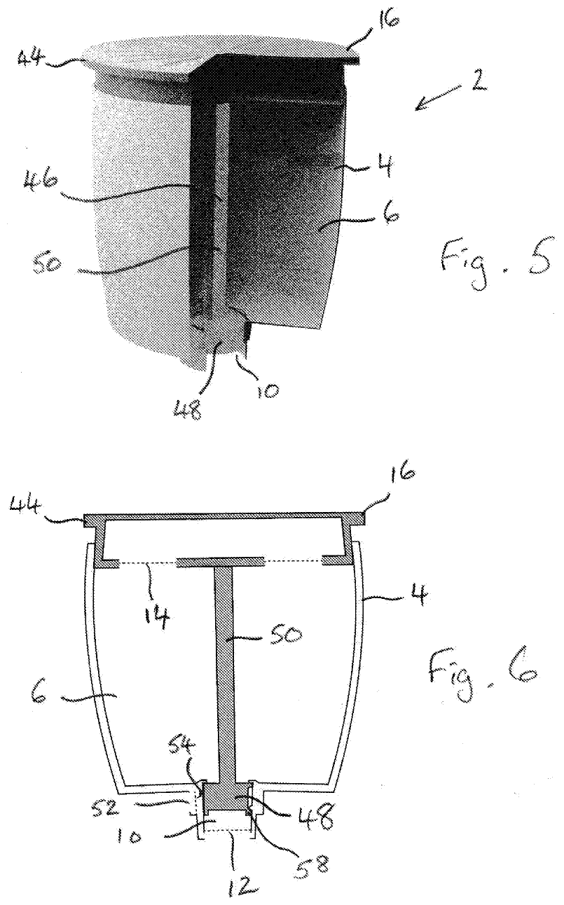

FIG. 5 is a perspective view of a second embodiment of the brewing cartridge device with a cut-away portion to show the interior of the cartridge,

FIG. 6 is schematic cross-sectional view of the second embodiment,

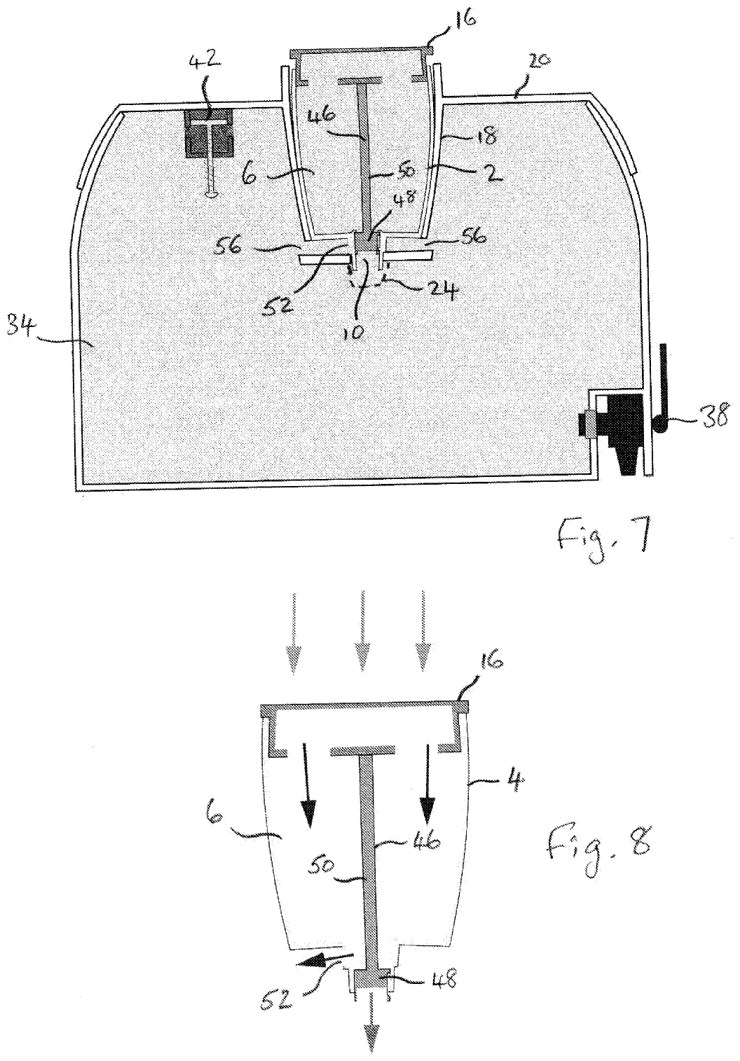

FIG. 7 is schematic cross-sectional view of the second embodiment mounted into the cartridge chamber of the fermentation chamber, and

FIG. 8 is a view similar to FIG. 4, but of the second embodiment.

Referring to FIG. 1, a brewing cartridge device 2 comprises a cartridge body 4 which defines a first substance-containing part 6 in the form of a first ingredient chamber. A base wall 8 of the cartridge device 2 is formed so as to form a second substance-containing part 10 in the form of a second ingredient chamber located between the underside of the base wall 8 and a seal 12 covering substantially the whole of the underside surface of the base wall 8, the second substance-containing part 10 being in the form of an inverted concave cavity. The volumetric space of the first substance-containing part 6 is larger than that of the second substance-containing part 10. For brewing purposes, the first substance-containing part 6 is for holding a first ingredient, for example, a brew extract product, such as wine extract or malt extract. The upper end of the first substance-containing part 6 comprises a second seal 14 and the second substance-containing part 10 is for holding a second ingredient which needs to be kept separated from the contents of the first substance-containing part 6, such as a yeast product. At an upper fluid entry end of the cartridge device 2, and above the seal 14, an optional filtering device 16 may be provided to filter a liquid, such as water, when the cartridge device is operational. The filtering device 16 preferably includes on its underside seal-opening elements 17 arranged to open the seal 14 at the appropriate time, as will be described hereinbelow.

The seals 12 and 14 can, as well as retaining the first and second ingredients in a safe manner, may also act as tamper-evident seals upon a visual inspection of them prior to use of the cartridge 2. The seals 12 and 14 may be of any suitable form and may or may not be removable from the cartridge device 2. For example, the seals 12 and 14 may be removable or pierceable seals or they may be slidable or rotatable ones to reveal one or more openings.

Referring to FIG. 2, the cartridge device 2 of any desired cross-sectional shape is shown inserted into a cartridge-receiving device 18 which in the example shown is a cavity or pocket integrally formed in a lid 20 of a fermentation container, although the cartridge device 2 could also be mounted in the cartridge-receiving device 18 at any convenient location on the fermentation container. A removable cartridge-receiving pocket would also be a possible alternative. The pocket 18 comprises an outer wall portion which receives tightly, with an interference fit, the cartridge device 2. At the base of the pocket 18, one or more releasing means including second seal-opening elements 22 are provided to open the seal 12 at the appropriate time, as will be described hereinbelow. In a central region of the underside of the pocket 18, there is a relatively small receptacle 24 which, when the cartridge device 2 is in place, aligns with the second substance-containing part 10 and the releasing means further includes seal-opening means 26 arranged to break the seal 12 at the mouth of the second ingredient chamber 10 in order to release the contents thereof into the receptacle 24. A part of the wall of the receptacle 24 is preferably partially or wholly composed of a fine mesh material.

Projecting substantially orthogonally from the outer surface of the main horizontal portion of the lid 20 is a neck portion 28 which is externally threaded to receive a correspondingly threaded further unit. Such a further unit can be a water container or a lid section useful for applying an initiating action to activate the cartridge device 2 and/or making fluid tight the fermentation container once fermentation starts. FIG. 3 shows a vertical stack brewing apparatus 30 which includes a water container 32 feeding a fermentation container 34 with a liquid which flows through the cartridge device 2 located in the pocket 18. A storage container 36 is located beneath the fermentation container 34 to receive fermented liquid ready to be stored and/or imbibed. A first valve device 38 enables transfer of fermented liquid from the fermentation container 34 to the storage container 36 and a second valve device 40 enables fermented liquid in the storage container 36 to be extracted for drinking and/or bottling. In addition, an airlock 42 is located in the lid 20.

To use the cartridge device 2 and referring to FIG. 4, it is mounted into the pocket 18 to a level indicated upon the outside surface of the cartridge body 4. The water container 32 is then connected to the threaded neck portion 28 above by way of the corresponding threaded portion on the water container. Of course, another suitable form of mechanical locking arrangement between the water container 32 and the fermentation container 34 is possible. The initiating action by applying an activation force upon connecting together of the water container 32 and the fermentation container 34 transfers onto the cartridge device 2 in the pocket 18. This transfer of the activation force is created, in the embodiment shown, by the twisting of the water container 32 causing downward movement of an internal shoulder 43 in the threaded outlet portion of the water container (see FIG. 3). This connecting together of the water container 32 and the fermentation container 34 also creates a liquid-tight seal ensuring that no liquid escapes during the transfer between the water container 32 and the fermentation container 34. The internal shoulder 43 acts upon either the top edge of the water filtering device 16 if present, or alternatively, on the top edge of the cartridge body 4. When using the water filtering device 16, an outwardly protruding rim 44 and the top edge of the cartridge body 4 serve to limit the maximum movement of the filtering device 16 into the cartridge body 4, whilst the gradually converging diameter of the upper section of the cartridge body 4 ensures a tight interference fit with the corresponding shaped side edges of the lower section of the filtering device 16.

Once the water container 32 has been fully and completely connected to the fermentation container 34, the cartridge device 2 would have simultaneously moved into a fully engaged position in the pocket 18 and seals 12 and 14 broken by the respective seal-opening elements 17 and 22 on the underside of the water filtering device 16, if present, and on the inner surface of the base wall of the pocket 18. If the filtering device 16 is not required, the seal 14 can be removed in another way such as by hand or by using an alternative seal-opening means. The opening of the seal 14 will allow liquid to flow through the filtering device 16 (if present) into the first substance-containing part 6 and mix with the brewing extract contained therein. The opening of seal 12 will allow the contents of the second substance-containing part 10, preferably a yeast product, to exit the cartridge 2 and occupy the receptacle 24.

In this first embodiment, liquid in the form of water is purified when flowing through the filtering device 16, which may comprise an ion exchange resin and activated carbon or contain any other suitable filtering material. As can be seen from FIG. 4, once the cartridge device 2 is in the fully engaged position in the pocket 18, the mixture of water and the brewing extract from the first substance-containing part 6 flows into the fermentation container 34 by way of openings (not shown) in the base wall 8 of the cartridge device 2 and the pocket 18. It is to be noted that there is no fluid communication between the first and second substance-containing parts 6 and 10 because if the yeast came into contact with any part of the concentrated brewing extract it could be significantly damaged and thereby prevent sufficient fermentation taking place.

The seal-opening elements 26 at the bottom of the pocket 18 allows the yeast contained in the second ingredient chamber 10 to drop into the receptacle 24 which is preferably partially or wholly composed of a mesh material to allow for flooding of the receptacle 24 as the liquid level in the fermentation container 34 rises. Once flooded, the yeast can propagate throughout the volume of liquid in the fermentation container 34. Owing to the second substance-containing part 10 being raised off the floor of the fermentation container 34, it ensures the water/brewing extract mixture is dilute enough to not damage the yeast.

Once the volume of water in the water container 32 has completely transferred into the fermentation container 34, the connection between those two elements can be released and the cartridge device 2 removed from the pocket 18 to be discarded or recycled. With the water container 32 removed, a fermentation container seal can be connected to the fermentation chamber lid 20 to create an air-tight seal for fermentation to take place, with any gas produced during the fermentation process escaping via the airlock 42. The water container 32 can be so shaped as to be then placed upside-down over the fermentation container 34.

A tamper-evident ring, or other suitable tamper-evident means, can be located between the rim of the filtering device 44 and the top edge of the cartridge body 4 to serve as a safety seal to prevent accidental operation of the cartridge and also serve to detect any undesired interference with the cartridge prior to use.

Referring to FIGS. 5 to 8, a second embodiment of the cartridge device 2 operates in a similar manner, except that the pocket 18 does not include seal-opening elements 22 and 26 but the releasing means includes a plunger device 46 extending substantially longitudinally of the cartridge device 2 from its top region to the second substance-containing part 10 which, in this second embodiment, projects outwardly beneath the first substance-containing part 6. The filtering device 16, if provided, as with the first embodiment described above, contains components to purify liquid water which flows from the water container 32 before passing through the filtering device 16. The plunger device 46 serves to separate and release ingredients from the first and second substance-containing parts 6 and 10 as required. The initiating action in this embodiment is delivered by way of a force applied on the plunger device 46 to allow the ingredient contents to leave the cartridge device. Such force may be from the pressing the filtering device 16 inwardly of the cartridge device 2 to move a plunger head 48 attached to one end of a plunger shaft 50 and located in the second substance-containing part 10.

As mentioned above, the second substance-containing part 10 holds an ingredient, such as the yeast product that must be kept separate from the contents of the first substance-containing part 6.

In use, the cartridge device 2 is placed in the pocket 18 and the water container 32 connected to the fermentation container 34 as described above. In the vertical brewing stack, downward pressure applied to the cartridge device 2 will open the seals 12 and 14 for the ingredients to enter the fermentation container 34. Once the seal 12 to the second substance-containing part 10 is open, the yeast is arranged to fall into the receptacle 24.

As water (purified by the filtering device 16 if present) flows through the cartridge device 2 assisted by gravity, it will mix with the content in the first substance-containing part 6 and the mixed solution is directed to flow into the fermentation container 34 by way of an outlet channel 52 in the wall of the second substance-containing part 10 opened by the movement of the plunger head 48. The outlet channel 52 may also be provided with a seal 54 to be removed prior to use of the cartridge 2 simply by peeling it away or by any other suitable means. Prior to movement of the plunger head 48, the outlet channel 52 is blocked by the plunger head 48. The mixed solution will come in to contact with the yeast in the receptacle 24 as the fluid level in the fermentation container 34 rises above the level of the receptacle 24 so that the yeast can then propagate throughout the mixed solution. The pocket 18 also includes at least one opening 56 located at substantially the same level as the outlet channel 52 to ensure a sufficient flow of the mixed solution into the fermentation container 34.

The filtering device 16, if provided, is retained by the cartridge body 4 in the same manner as the first embodiment described above.

Again, a tamper-evident ring, or other suitable tamper-evident means, can be located between the rim of the filtering device 44 and the top edge of the cartridge body 4.

The shaft 50 of the plunger device 46 can be free or it could be retained within a channel of the cartridge device 2, such a channel being arranged to allow sufficient movement of the plunger device to open the seal 14. The plunger head 48 preferably includes a seal-opening element 58 which, when the initiating force is applied to the plunger device 46, the seal-opening element 58 contacts the seal 12 and opens it allowing the contents from second substance-containing part 10 to drop into the receptacle 24. The shaft 50 of the plunger device 46 may be detachable from the plunger head 48.

As an alterative to the second substance-containing part 10 being an integral part of a plastics-moulded cartridge device 2, the second substance-containing part 10 may be a compartment within the cartridge device 2 separated from the first substance-containing part 6 by a removable barrier temporarily separating the respective substances, the removable barrier being removed manually, electrically, mechanically or chemically. As a further alternative, the second substance-containing part 10 may be in the form of a pouch-like compartment located inside the first substance-containing part 6 (which may also be separated from the first substance-containing part 6 by a similar removable barrier), whereby the action applied to open the seals 12 and 14 and to put the cartridge in the fully engaged position causes the ingredient in the pouch-like second substance-containing part 10 to be released for entry into the fermentation container 34.

The cartridge device 2 may, in addition to the first and second substance-containing part 6 and 10, include other substance-containing parts allowing for other brewing ingredients to be stored without mixing with other ingredients until the right moment in the brewing process. Examples of such other ingredients are hops or a flavoured extract to impart a further taste element to the final brewed product.

The cartridge body 4 is preferably tapered in order to aid in extraction from the pocket after use.

All the materials used for the cartridge and the seals are to be approved food-safe materials.

The cartridge device may, advantageously, be supplied as an element to a kit of parts containing at least the fermentation chamber 34 including the pocket 18. The cartridge device could also be available individually so that different types of alcoholic beverage can be made using the same apparatus.

1. Apparatus comprising a cartridge device having a liquid inlet, a first substance-containing part downstream of the liquid inlet and for containing a first substance, and a second substance-containing part for containing a second substance, the second substance being separated from the first substance, the arrangement being such that releasing means serve to release the first and second substances from the respective first and second substance-containing parts.

2. Apparatus according to claim 1, wherein the cartridge device is mounted to a vertical brewing stack.

3. Apparatus according to claim 1 or 2, wherein the first substance-containing part is relatively large in volume and contains a concentrated brew extract and the second substance-containing part is smaller in volume and contains a quantity and type of yeast and/or any non-liquid ingredients usable to start a fermentation process.

4. Apparatus according to any preceding claim, wherein the cartridge device may further include a liquid filtering device fitted into the liquid inlet.

5. Apparatus according to any preceding claim, wherein top and bottom end regions of the cartridge device are sealed with openable seals.

6. Apparatus according to claim 5 as appended to claim 4, wherein the filtering device includes on its underside seal-opening elements.

7. Apparatus according to any preceding claim, wherein the second substance-containing part is in the form of a chamber formed integrally of the cartridge device.

8. Apparatus according to any one of claims 1 to 6, wherein the second substance-containing part is a compartment separated from the first substance-containing part by a temporary membrane device.

9. Apparatus according to any one of claims 1 to 6, wherein the second substance-containing part is a pouch-like part inserted into the cartridge device.

10. Apparatus according to any one of claims 1 to 7, wherein the releasing means includes a plunger device extending substantially longitudinally of the cartridge device from its top region to the second substance-containing part which projects outwardly beneath the first substance-containing part.

11. Apparatus according to claim 10, wherein the plunger device serves to separate and release ingredients from the first and second substance-containing parts.

12. A method of brewing comprising mounting to a fermentation container a cartridge device having a liquid inlet, a first substance-containing part downstream of the liquid inlet and for containing a first substance, and a second substance-containing part for containing a second substance, the second substance being, initially, separated from the first substance, and subsequently releasing the first and second substances from the respective first and second substance-containing parts, directing liquid to flow into the liquid inlet and into the first substance-containing part to mix with the first substance, the mixed liquid flowing through a liquid outlet of the cartridge device to the fermentation container, the mixed liquid coming into contact with the released second substance.

13. A method according to claim 12, and further comprising an initiation of the cartridge device serving to release the first and second substances from their respective parts to initiate a fermentation process.

14. A method according to claim 13, wherein said initiation is delivered by way of a force applied on a plunger device to allow the first and second substances to leave the cartridge device.

15. A method according to any one of claims 12 to 14, and further comprising filtering at the liquid inlet end of the cartridge device to filter a liquid.

16. A method according to claim 15 as appended to claim 14, wherein an initiation force is applied by pressing a filtering device inwardly of the cartridge device to move a plunger head of the plunger device and located in the second substance-containing part.

17. A method according to any one of claims 12 to 16, wherein top and bottom end regions of the cartridge device are sealed with openable seals, the method further comprising opening the seals when mounting the cartridge device to the fermentation container.

18. Brewing apparatus comprising a fermentation container, a brewing ingredient cartridge device serving to supply a brewing ingredient contained in the cartridge to the fermentation container, the fermentation chamber including a cartridge-receiving device for mounting the cartridge to the fermentation container.

19. A method of brewing comprising mounting a brewing ingredient cartridge device to a cartridge-receiving device of a fermentation container, directing a flow of liquid through the cartridge device mounted in the cartridge-receiving device so as to deliver a brewing ingredient contained in the cartridge device into the fermentation chamber.
